(19) United States
(12) Patent Application Publication
(10) Pub. No.: US 2017/0179691 A1
(43) Pub. Date: Jun. 22, 2017

(54) REMOTELY OPERATED POWER PEDESTAL AND POWER PEDESTAL CONTROL SYSTEM INCLUDING THE SAME

(71) Applicant: EATON CORPORATION, Cleveland, OH (US)

(72) Inventors: JASON DEMETRIOS EASTON, Williamsburg, VA (US); Chris Emmons Drueke, Williamsburg, VA (US); Paul David Seff, Williamsburg, VA (US); Jeffery Scott Kuykendall, Williamsburg, VA (US)

(73) Assignee: EATON CORPORATION, Cleveland, OH (US)

(21) Appl. No.: 14/972,513

(22) Filed: Dec. 17, 2015

(51) Int. Cl. H02B 1/50

(52) U.S. Cl. CPC H02B 1/50

(57) ABSTRACT

A power pedestal including a pedestal member including a base structured to be mounted to a mounting member and an enclosure extending from the base. The power pedestal also includes an indicator structured to provide an indication and a wireless communication unit structured to receive wireless communication from an external device and to control the indicator based on the received wireless communication.

### BACKGROUND

Field of the Invention

The disclosed concept pertains generally to power pedestals and, more particularly, to marina power pedestals. The disclosed concept also pertains to control systems for power pedestals.

Background Information

U.S. Pat. No. 6,844,716 discloses a utility distribution pedestal for marine and recreational vehicles. Known power pedestals include various components such as receptacles, circuit breakers and lighting. To turn these components on or off, a user must approach the power pedestal and turn them on or off at the power pedestal. While turning components on or off at the power pedestal has been satisfactory, there is still room for improvement in vehicle or marina power pedestals.

### SUMMARY

These needs and others are met by embodiments of the disclosed concept wherein a power pedestal includes a wireless communication unit structured to wirelessly receive a communication and to control an indicator based on the received communication.

In accordance with one aspect of the disclosed concept, a power pedestal comprises: a pedestal member comprising: a base structured to be mounted to a mounting member, and an enclosure extending from the base; an indicator structured to provide an indication; and a wireless communication unit structured to receive wireless communication from an external device and to control the indicator based on the received wireless communication.

In accordance with another aspect of the disclosed concept, a power pedestal control system comprises: a user device structured to provide a communication; and a number of power pedestals each comprising: a pedestal member comprising: a base structured to be mounted to a mounting member, and an enclosure extending from the base; an indicator structured to provide an indication; and a wireless communication unit structured to wirelessly receive the communication and to control the indicator based on the wirelessly received communication.

### BRIEF DESCRIPTION OF THE DRAWINGS

A full understanding of the invention can be gained from the following description of the preferred embodiments when read in conjunction with the accompanying drawings in which:

FIG. 1 is an isometric view of a marina power pedestal in accordance with embodiments of the disclosed concept.

FIG. 2 is an isometric view of the input power terminals of the marina power pedestal of FIG. 1.

FIG. 3 is a schematic diagram of a power pedestal control system in accordance with an example embodiment of the disclosed concept.

FIG. 4 is a schematic diagram of a power pedestal control system in accordance with another example embodiment of the disclosed concept.

FIG. 5 is a schematic diagram of a power pedestal control system in accordance with another example embodiment of the disclosed concept.

FIG. 6 is a schematic diagram of a ground fault protection circuit in accordance with embodiments of the disclosed concept.

FIG. 7 is a view of an indicator in accordance with example embodiments of the disclosed concept.

### DESCRIPTION OF THE PREFERRED EMBODIMENTS

As employed herein, the term “vehicle” shall expressly include, but not be limited by, a land vehicle, a marine vehicle, an air vehicle or another motor vehicle.

As employed herein, the term “land vehicle” shall expressly include, but not be limited by, any land-based vehicles having pneumatic tires, any rail-based vehicles, any maglev vehicles, automobiles, cars, trucks, station wagons, sport-utility vehicles (SUVs), recreational vehicles, construction vehicles, off road vehicles, all-terrain vehicles, farm vehicles, fleet vehicles, motor homes, vans, buses, motorcycles, mopeds, campers, trailers, or bicycles.

As employed herein, the term “marine vehicle” shall expressly include, but not be limited by, any water-based vehicles, ships, boats, other vessels for travel on water, submarines, or other vessels for travel under water.

As employed herein, the term “air vehicle” shall expressly include, but not be limited by, any air-based vehicles, airplanes, jets, aircraft, airships, balloons, blimps, or dirigibles.

As employed herein, the term “number” shall mean one or an integer greater than one (i.e., a plurality).

As employed herein, the term “platform” shall mean a horizontal flat surface, a raised horizontal flat surface, or a dock pier.

As employed herein, the term “pedestal” or “pedestal member” shall mean an elongated, generally upright structure.

As employed herein, the term “power pedestal” shall mean a pedestal or pedestal member structured to input power from input power terminals (e.g., utility power terminals) and output power to a number of output power receptacles.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

The disclosed concept is described in association with a marina power pedestal, although the disclosed concept is applicable to a wide range of vehicle power pedestals.

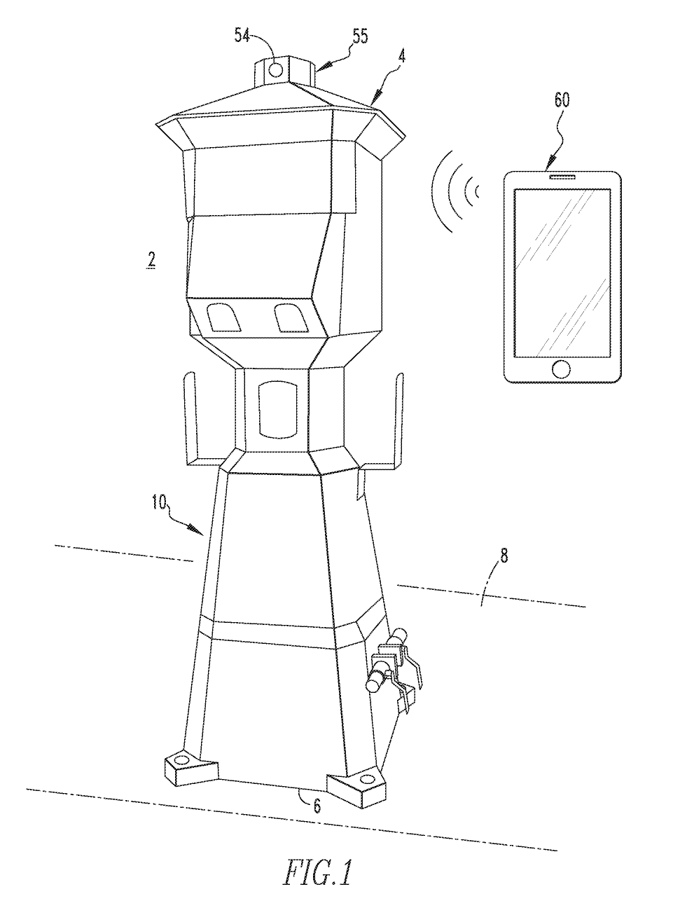

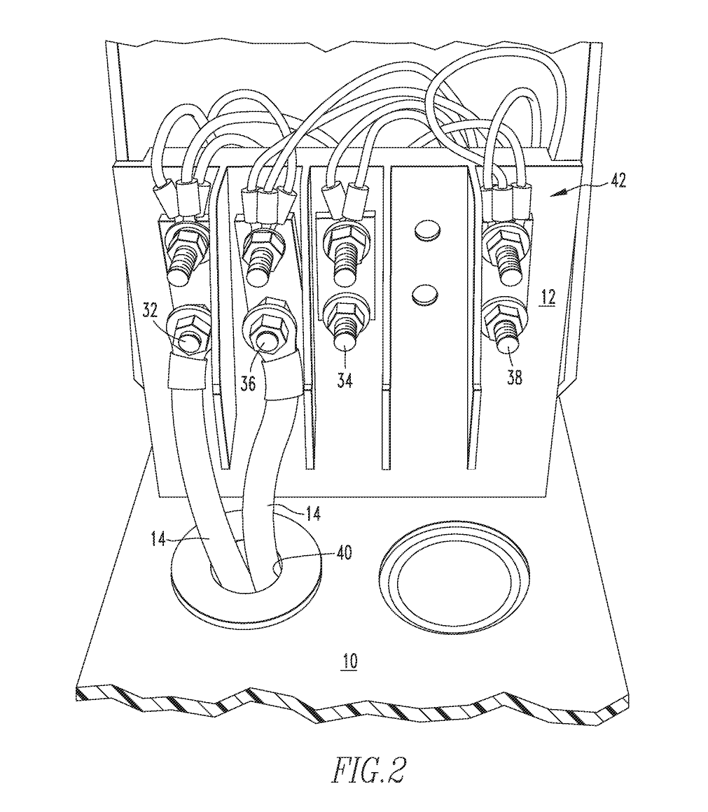

Referring to FIGS. 1 and 2, a power pedestal, such as, for example and without limitation, a marina power pedestal 2 includes a pedestal member 4 having a base 6 structured to be mounted or fixed to a mounting member, such as, for example and without limitation, a platform. In the example shown, the platform is a dock pier 8 (shown in phantom line drawing) and an enclosure 10 extending generally vertically from the base 6. A plurality of input power terminals 12 (shown in FIG. 2) are mounted to the pedestal member 4 and are structured to be electrically connected to a power source (e.g., a utility power source) (not shown) by plural electrical conductors 14 (shown in FIG. 2). The marina power pedestal 2 also includes a number of output power receptacles 16 (shown in FIG. 6) mounted to the enclosure 10. In some example embodiments of the disclosed concept, the marina power pedestal 2 further includes a number of circuit interrupters, such as, for example and without limitation, ground fault circuit interrupters (GFCIs) 68 (shown in FIG. 6) or other types of circuit breakers.

Referring to FIG. 2, the input power terminals 12 of the marina power pedestal 2 of FIG. 1 are shown. These terminals 12 include a first line terminal 32 (LINE1), a second line terminal 34 (LINE2), a neutral terminal 36 and a ground terminal 38. As shown by the two example electrical conductors 14, the terminals 32,34,36,38 are structured to be electrically connected to a suitable power source (not shown) by those conductors 14, which extend through the opening 40. It will be appreciated that the other terminals 34,38 may also be electrically connected to the power source by other electrical conductors (not shown). The other electrical conductors 42 are electrically connected to the GFCIs 68 and the output power receptacles 16 (see FIG. 6).

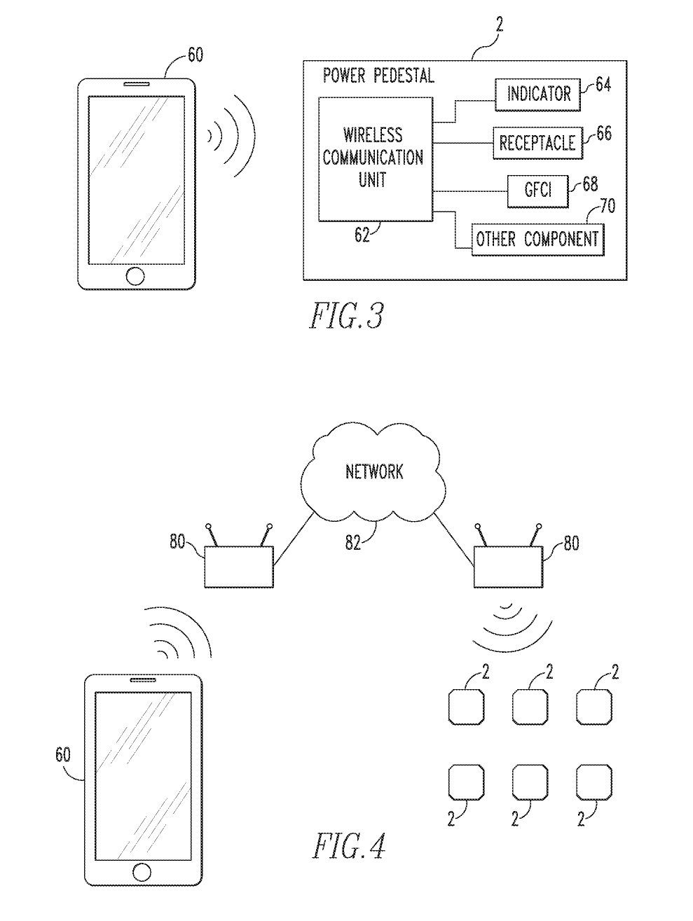

The power pedestal 2 further includes an indicator 64 (shown in FIGS. 3 and 7). The indicator 64 is structured to provide an indication to a person outside the enclosure 10 of the power pedestal 2. In some example embodiments of the disclosed concept, the indication is a visual indication and the indicator 64 may be a light source such as, for example and without limitation, a light emitting diode (LED). If further example embodiments of the disclosed concept, the indicator 64 can provide different color indications and may be a multi-color light source such as, without limitation, a multi-color LED. The indicator 64 may also include multiple light sources such as, without limitation, multiple LEDs of different colors. In some other example embodiments of the disclosed concept, the indicator 64 may provide an audible indication such as a sound.

Various components of the power pedestal 2 such as, without limitation, the indicator 64, the output power receptacles 66 and the GFCI 68 may be controlled by a user device 60 via wireless communication with the power pedestal 2. Controlling components of the power pedestal 2 with the user device 60 will be described in more detail hereinafter.

FIG. 3 is a schematic diagram of the power pedestal 2 and user device 60 in accordance with an example embodiment of the disclosed concept. The power pedestal 2 includes a wireless communication unit 62 as well as the indicator 64, the output power receptacles 66, the GFCI 68 and other components 70 that may be controlled. The wireless communication unit 62 is structured to receive wireless communication from the user device 60. The wireless communication unit 62 is also structured to control components of the power pedestal 2 such as the example indicator 64, output power receptacles 66, GFCI 68 and other components 70 based on the received wireless communication. For example and without limitation, the wireless communication unit 62 may turn on and turn off the indicator 64, output power receptacles 66, GFCI 68 and other components 70 based on the received wireless communication. The wireless communication unit 62 may also provide other control such as, without limitation, controlling the color of the indicator 64.

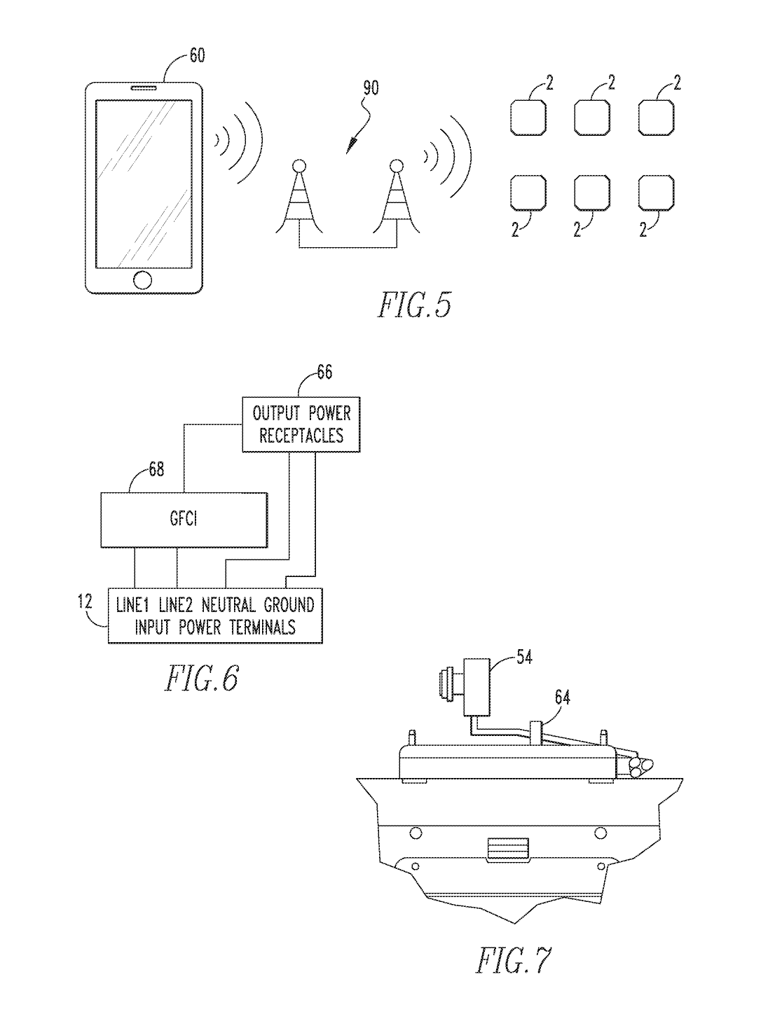

In some example embodiments of the disclosed concept, the wireless communication unit 62 is structured to receive wireless communication directly from the user device 60. The wireless communication may be received via any suitable protocol such as, without limitation, Bluetooth, Zigbee, Z-wave, any suitable radio protocol, or any other suitable wireless communication protocol. In some other example embodiments of the disclosed concept, other intermediate components such as, without limitation, wireless routers 80 and a network 82 (shown in FIG. 4) or a cellular communication network 90 (shown in FIG. 5) are disposed between the user device 60 and the wireless communication unit 62 and will be described in more detail with respect to FIGS. 4 and 5.

Referring to FIG. 4, a schematic diagram of power pedestals 2 and the user device 60 in accordance with an example embodiment of the disclosed concept is shown. Although not shown in FIG. 4, each of the power pedestals 2 include the wireless communication unit 62. As shown in FIG. 4, wireless routers 80 and the network 82 (e.g., without limitation, the internet) are disposed between the power pedestals 2 and the user device 60. In this example embodiment, the user device 60 transmits a wireless communication to one of the wireless routers 80. The wireless router 80 then transmits the communication to the other wireless router 80 via the network 82. The other wireless router 80 then wirelessly transmits the communication to the wireless communication units 62 in the power pedestals 2. The wireless communication unit 62 then control their various components based on the wireless communication. In this example embodiment, the wireless communication unit 62 unit may be structured to receive wireless communication via a protocol such as, without limitation, wi-fi, any suitable radio protocol, or any other suitable wireless communication protocol.

Although not shown in FIG. 4, it is contemplate the user device 60 may communicate with the network 82 via a wired connection, rather than via a wireless communication. For example and without limitation, the user device 60 may be a computer wired to a router or the network 82. The communication from the user device 60 may then be wirelessly transmitted to the power pedestals 2 via the wireless router 80.

Referring to FIG. 5, a schematic diagram of power pedestals 2 and the user device 60 in accordance with an example embodiment of the disclosed concept is shown. Although not shown in FIG. 5, each of the power pedestals 2 include the wireless communication unit 62. As shown in FIG. 5, the cellular communication network 90 is disposed between the power pedestals 2 and the user device 60. In this example embodiment, the user device 60 transmits a wireless communication to the cellular communication network 90. The cellular communication network 90 then wirelessly transmits the communication to the wireless communication units 62 in the power pedestals 2. The wireless communication unit 62 then control their various components based on the wireless communication. In this example embodiment, the wireless communication unit 62 unit may be structured to receive wireless communication via a cellular communication protocol, any suitable radio protocol, or any other suitable wireless communication protocol.

The user device 60 may be any electronic device capable of providing communication to the power pedestals 2 directly or via intermediate components such as the network 82 or cellular communication network 90. It is contemplated that the user device 60 may be, without limitation, a mobile phone, a laptop computer, a desktop computer, a tablet or any other suitable electronic device without departing from the scope of the disclosed concept.

In some example embodiments of the disclosed concept, the communication provided by the user device 60 is provided to just one power pedestals 2. In some other example embodiments of the disclosed concept, the communication provided by the user device 60 is provided to multiple power pedestals 2. As such, components of multiple power pedestals 2 may be controlled via a single user device 60 without the need to physically approach any of the power pedestals 2.

In some example embodiments of the disclosed concept, the power pedestals 2 include an indicator 64 that is capable of producing different color indications. The user device 60 can communication with the power pedestals 2 to control the color of the indicators 64. This type of control can be used to provide alert at one of the power pedestals 2 by changing the color of the indicator 64 to a certain color. Additionally, the user device 60 can control the color of the indicators 64 to change to provide an aesthetically pleasing effect. For example and without limitation, the user device 60 can control the indicators 64 in the power pedestals 2 in a marina to cycle through colors to provide an aesthetic effect at the marina.

Referring to FIG. 6 a schematic diagram of a ground fault protection circuit is shown. The ground fault protection circuit includes the input power terminals 12, the output power receptacles 66 and the GFCI 68. As previously described, the input power terminals 12 are mounted to the pedestal member 4 and are structured to be electrically connected to a power source (e.g., a utility power source) (not shown). The input power terminals 12 are electrically connected to the output power receptacles 66. In more detail, NEUTRAL and GROUND electrical connections of the input power terminals 12 are electrically connected to the output power receptacles 66 and LINE1 and LINE2 electrical connections of the input power terminals 12 are electrically connected to the output power receptacles 66 via the GFCI 68. The GFCI 68 has the capability of detecting a ground fault on the power circuit. When the GFCI 68 detects a ground fault, it trips open, electrically disconnecting the corresponding output power receptacle from LINE1 or LINE2.

FIG. 7 is an enlarged view of a portion of an upper housing 55 (shown in FIG. 1) of the power pedestal 2 in accordance with an example embodiment of the disclosed concept, shown with the cover removed to illustrate internal components that would otherwise be enclosed and thus hidden. In the example embodiment of FIG. 7, the indicator 64 is a light source such as, without limitation, an LED. FIG. 7 shows the area inside the power pedestal 2 where the indicator 64 is located. Since the indicator 64 is located in a top portion of the power pedestal 2, it is easy to see when it is illuminated. Also, the upper housing 55 of the power pedestal 2 includes transparent or translucent exterior panels so that light from the indicator 52 can be seen from outside the power pedestal 2.

In some example embodiments of the disclosed concept, the power pedestal 2 further includes a photocell 54. The photocell 54 provides ambient light detection which can be used to turn off lights on the power pedestal 2 when it is light outside in order to save power.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof

1. A power pedestal comprising:
a pedestal member comprising:
a base structured to be mounted to a mounting member, and
an enclosure extending from the base;
an indicator structured to provide an indication;
a ground fault interrupter, and
a wireless communication unit structured to receive wireless communication from an external device and to control the indicator and the ground fault circuit interrupter based on the received wireless communication.

2. The power pedestal of claim 1, wherein the wireless communication unit is structured to receive the wireless communication via a cellular protocol.

3. The power pedestal of claim 1, wherein the wireless communication unit is structured to receive the wireless communication via a wi-fi protocol.

4. The power pedestal of claim 1, wherein the indicator is capable of providing a plurality of different color indications; and wherein the wireless communication unit is structured to control the indicator to selectively provide color indications based on the received wireless communication.

5. The power pedestal of claim 4, wherein the indicator is a multi-color light source.

6. The power pedestal of claim 4, wherein the indicator includes a plurality of light sources, each having a different color.

7. The power pedestal of claim 1, wherein the indicator is disposed in an upper housing of the power pedestal; and wherein the upper housing includes transparent or translucent panels.

8. The power pedestal of claim 1, further comprising:
a receptacle,
wherein the wireless communication unit is structured to control the receptacle based on the received wireless communication.

9. A power pedestal control system comprising:
a user device structured to provide a communication; and
a number of power pedestals each comprising:
a pedestal member comprising:
a base structured to be mounted to a mounting member, and
an enclosure extending from the base;
an indicator structured to provide an indication;
a ground fault circuit interrupter; and
a wireless communication unit structured to wirelessly receive the communication and to control the indicator and the ground fault circuit interrupter based on the wirelessly received communication.

10. The power pedestal control system of claim 9, wherein the user device is structured to wirelessly transmit the communication directly to at least one of the number of power pedestals.

11. The power pedestal control system of claim 9, wherein the user device is structured to provide the communication to a network; and wherein a network device is structured to receive the communication from the network and wirelessly provide the communication to at least one of the number of power pedestals.

12. The power pedestal control system of claim 11, wherein the wireless communication unit is structured to receive the wireless communication via a wi-fi protocol.

13. The power pedestal control system of claim 9, wherein the user device is structured to provide the communication to a cellular communication network; and wherein the cellular communication network is structured to wirelessly provide the communication to at least one of the number of power pedestals.

14. The power pedestal control system of claim 13, wherein the wireless communication unit is structured to receive the wireless communication via a cellular protocol.

15. The power pedestal control system of claim 9, wherein the user device is at least one of a mobile phone, a laptop computer, a desktop computer and a tablet.

16. The power pedestal control system of claim 9, wherein the indicator is capable of providing a plurality of different color indications; and wherein the wireless communication unit is structured to control the indicator to selectively provide color indications based on the communication.

17. The power pedestal control system of claim 16, wherein the indicator is a multi-color light source.

18. The power pedestal control system of claim 16, wherein the indicator includes a plurality of light sources, each having a different color.

19. The power pedestal control system of claim 9, wherein the number of power pedestals each further comprises:
a receptacle,
wherein the wireless communication unit is structured to control the receptacle based on the communication.

20. The power pedestal control system of claim 9, wherein the number of power pedestals is a plurality of power pedestals.
